(19) United States
(12) Patent Application Publication
(10) Pub. No.: US 2006/0126626 A1
(43) Pub. Date: Jun. 15, 2006

(54) System and method of sharing video head ends

(76) Inventors: Allen Tsz-Chiu Wong, San Jose, CA (US); Zhidan Cheng, Sunnyvale, CA (US)

Correspondence Address: LAW OFFICES OF MARK C. PICKERING, P.O. BOX 300, PETALUMA, CA, 94953, US

(21) Appl. No.: 10/996,893

(22) Filed: Nov. 23, 2004

(51) Int. Cl. H04L 12/56; H04J 3/26

(52) U.S. Cl. 370/390; 370/432

(57) ABSTRACT

An Internet Group Multicast Protocol (IGMP)-based communications system shares the digital television channels output by two different head ends to increase the number of television channels that can be provided to the end users by forwarding multicast data packets that represent the television channels from one access system to another access system.

### BACKGROUND OF THE INVENTION

1. Field of the Invention

The present invention relates to a system and method of utilizing video head ends and, more particularly, to a system and method of sharing video head ends.

2. Description of the Related Art

In a communications network that supports the Internet Group Multicast Protocol (IGMP), Version 1 (RFC 1112) and/or Version 2 (RFC 2236), multicast sources, such as video head ends, output streams of multicast data packets to the network. Each multicast data packet, in turn, has a multicast group address.

The multicast data packets can represent, for example, television channels that are identified by the multicast group addresses. For example, a multicast data packet of television channel 1 can have a first multicast group address, while a multicast data packet of television channel 2 can have a second multicast group address.

The multicast data packets (television channels) are forwarded through the public internet, or a similar communications network. The multicast data packets can then be received by an access system that provides an interface to a large number of end users, such as set top boxes.

FIG. 1 shows an example of a prior-art access system 100. As shown in FIG. 1, access system 100 includes a number of multicast line cards 110, and a number of host line cards 112. In addition, access system 100 has a fabric switch module card 114, a primary control module card 116, and a control bus 118.

Each multicast line card 110 is connected externally to receive multicast data packets that represent a number of television channels (which have a corresponding number of multicast group addresses), and internally to the host line cards 112 via fabric switch module card 114, where the host line cards 112 are forwarding destinations for the multicast data packets.

In addition, each of the multicast line cards 110 has a multicast forwarding table that determines how the received multicast data packets are forwarded. A multicast forwarding table lists all of the television channels (multicast group addresses) that are received by a multicast line card 110.

Further, for each received television channel (multicast group address), the multicast forwarding table lists of all of the host line cards 112 that are to receive the multicast data packets of the television channel, along with path information for fabric switch module card 114. For example, the multicast forwarding table can include a list of all of the host line cards 112 which are to receive television channel 3.

The host line cards 112, which can be implemented with xDSL line cards, are each connected to a number of end users 120, such as set top boxes. Each host line card 112 also has a multicast forwarding table that lists the television channels (multicast group addresses) that are to be forwarded to the end users 120 (e.g., set top boxes).

Fabric switch module card 114, which is connected to the multicast line cards 110 and the host line cards 112, passes data packets between the line cards at up to OC12 speeds. Primary control module card 116 receives non-packet control messages from, and outputs non-packet control messages to, the multicast line cards 110, the host line cards 112, and fabric switch module card 114 over control bus 118.

In operation, each multicast line card 110 receives multicast data packets of television channels from a forwarding unit, such as a router or a video head end. When a multicast data packet is received by a multicast line card 110, the multicast line card 110 determines the multicast group address of the packet, and checks the multicast forwarding table to determine which host line cards 112 are to receive the television channel represented by the multicast group address. In addition, the multicast line card 110 forwards the multicast data packet via fabric switch module card 114 to the host line cards 112 as indicated by the entries in the multicast forwarding table.

For example, a multicast line card 110A can receive television channels 1-50 (with corresponding multicast group addresses of 1-50) from a video head end A. When the end users 120 connected to a host line card 112A, as a group, receive all of the channels 1-50, the multicast forwarding table of the multicast line card 110A associates host line card 112A with all 50 of the received television channels. Thus, in this example, multicast line card 110A forwards all of the television channels 1-50 to host line card 112A to be forwarded to the end users 120.

When a company, such as the company which outputs television channels 1-50 to multicast line card 110A, wishes to increase the number of channels provided to the end users 120, the company must obtain a source for the additional television channels, and route the additional television channels to another multicast line card 110 in access system 100.

Constructing the routing can be a complex process, particularly when access system 100 is connected to a designated router which, in turn, is connected to a router that functions as a rendezvous point in a protocol independent multicast (PIM) architecture. Thus, there is a need for a simple approach to providing additional television channels.

### SUMMARY OF THE INVENTION

The present invention provides an access system that includes a host line card that is connectable to an end user, and a multicast line card that is electrically connected to the host line card to pass packets of data to the host line card. The multicast line card receives a multicast data packet that has a multicast group address. The multicast line card has a multicast forwarding table that includes the multicast group address and an indication of whether the multicast data packet with the multicast group address is to be forwarded to the host line card.

The present invention also provides an access system that includes a plurality of host line cards. Each host line card, in turn, is connected to a plurality of end users. The access system also includes a multicast line card that is electrically connected to the host line cards to pass packets of data to the host line cards. The multicast line card receives a plurality of multicast data packets that have a plurality of multicast group addresses. The multicast line card has a multicast forwarding table that defines the host line cards that are to receive the multicast data packets with the multicast group addresses. The access system additionally includes an intersystem line card. The multicast line card is electrically connected to the intersystem line card to pass data packets to the intersystem line card. The intersystem line card is not connected to any end users.

The present invention further includes a communications network that includes a first access system and a second access system. The first access system includes a plurality of first host line cards and a first multicast line card. The first multicast line card is electrically connected to the first host line cards to pass packets of data to the first host line cards. The first multicast line card receives a plurality of first multicast data packets that have a plurality of first multicast group addresses. The first multicast line card has a first multicast forwarding table that defines the first host line cards that are to receive the first multicast data packets with the first multicast group addresses. The first access system also includes a first intersystem line card. The first multicast line card is electrically connected to the first intersystem line card to pass packets of data to the first intersystem line card.

The second access system includes a plurality of second host line cards and a second multicast line card. The second multicast line card is electrically connected to the second host line cards to pass packets of data to the second host line cards. The second multicast line card receives a plurality of second multicast data packets that have a plurality of second multicast group addresses. The second multicast line card has a second multicast forwarding table that defines the second host line cards that are to receive the second multicast data packets with the second multicast group addresses. The second access system further includes a second intersystem line card. The second multicast line card is electrically connected to the second intersystem line card to pass packets of data to the second intersystem line card.

The present invention also includes a method of providing digital television service to an end user. The method includes the step of receiving a multicast data packet with a multicast line card. The multicast data packet has a multicast group address. The method also includes the step of forwarding the multicast data packet from the multicast line card to a host line card in accordance with a forwarding table that associates the multicast group address with the host line card.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block diagram illustrating a prior-art access system 100.

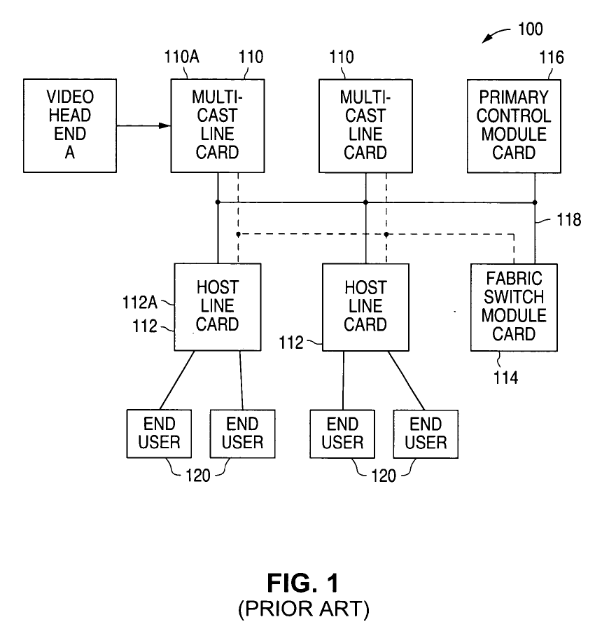

FIG. 2 is a block diagram illustrating an example of a communications system 200 in accordance with the present invention.

### DETAILED DESCRIPTION OF THE INVENTION

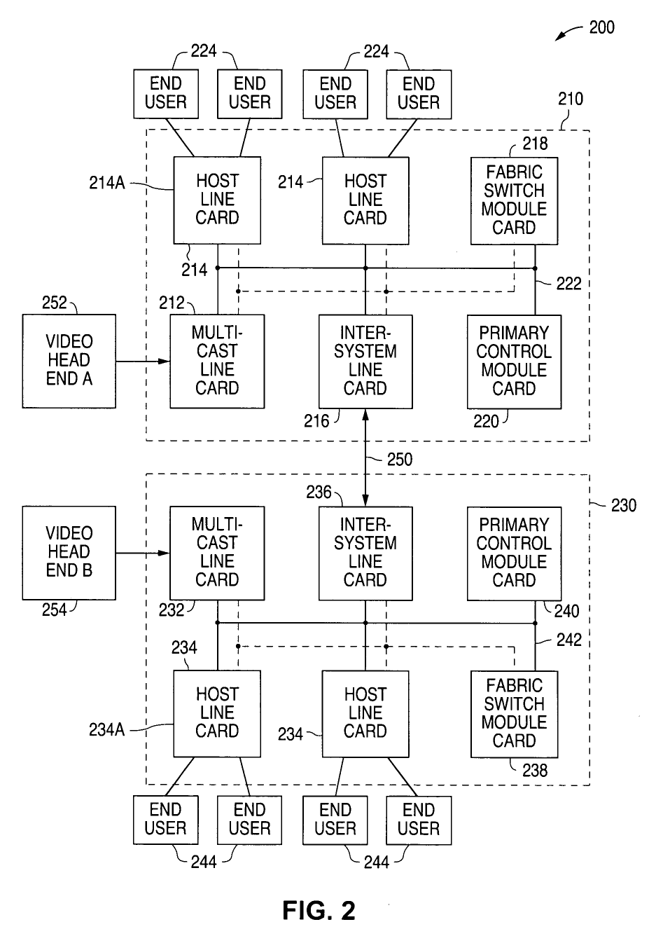

FIG. 2 shows a block diagram that illustrates an example of a communications system 200 in accordance with the present invention. As described in greater detail below, communications system 200 shares video head ends to increase the number of television channels that can be provided to the end users by forwarding multicast data packets from one access system to another access system.

As shown in FIG. 2, communication system 200 includes a first access system 210 which has a multicast line card 212, one or more host line cards 214, and an intersystem line card 216. In addition, access system 210 also has a fabric switch module card 218, a primary control module card 220, and a control bus 222.

Multicast line card 212 is connected externally to receive multicast data packets that represent a number of first television channels (which have a corresponding number of multicast group addresses), and internally to the host line cards 214 and intersystem line card 216 via fabric switch module card 218 as forwarding destinations for the multicast data packets.

In addition, multicast line card 212 has a multicast forwarding table that determines how the multicast data packets are forwarded. The multicast forwarding table lists all of the first television channels (multicast group addresses) that are received by multicast line card 212. Further, for each received television channel (multicast group address), the multicast forwarding table includes a list of all of the line cards that are to receive the multicast data packets of the television channel, along with path information for fabric switch module card 218.

The host line cards 214, which can be implemented with xDSL line cards, are connected to a number of end users 224, such as set top boxes. The host line cards 214 also have a multicast forwarding table that lists the television channels (multicast group addresses) that are to be forwarded to the end users 224 (e.g., set top boxes).

Intersystem line card 216 is connected externally to receive multicast data packets that represent a number of second television channels (which have a corresponding number of multicast group addresses), and to output multicast data packets that represent the first television channels.

Intersystem line card 216 is also connected internally to the host line cards 214 via fabric switch module card 218 as a forwarding destination for the multicast data packets of the second television channels, and internally to multicast line card 212 via fabric switch module card 218 to receive the multicast data packets of the first television channels. Further, in the present example, intersystem line card 216 is not connected to any end users 224, and can never be connected to any end users 224.

In addition, intersystem line card 216 has both an outgoing multicast forwarding table and an incoming multicast forwarding table. The outgoing multicast forwarding table lists all of the first television channels (multicast group addresses) that are received from multicast line card 212 and, for each received television channel, provides a forwarding destination for the multicast data packet.

The incoming multicast forwarding table lists all of the second television channels (multicast group addresses) that are received by intersystem line card 216 and, for each television channel (multicast group address), the multicast forwarding table includes a list of all of the host line cards 214 that are to receive the television channel, along with path information for fabric switch module card 218.

Fabric switch module card 218, which is connected to multicast line card 212, host line card 214, and intersystem line card 216, passes packets of data between the line cards at up to OC12 speeds. Primary control module card 220 receives non-packet control messages from, and outputs non-packet control messages to, multicast line card 212, the host line cards 214, intersystem line card 216, and fabric switch module card 218 over control bus 222.

As further shown in FIG. 2, communication system 200 includes a second access system 230 which, in the present example, is structurally identical to access system 210. As a result, access system 230 has a multicast line card 232, one or more host line cards 234, and an intersystem line card 236. In addition, access system 230 also has a fabric switch module card 238, a primary control module card 240, and a control bus 242.

Multicast line card 232 is connected externally to receive multicast data packets that represent the second television channels, and internally to the host line cards 234 and intersystem line card 236 via fabric switch module card 238 as forwarding destinations for the data packets of the second television channels.

In addition, multicast line card 232 has a multicast forwarding table that determines how the data packets are forwarded. The multicast forwarding table lists all of the second television channels (multicast group addresses) that are received by multicast line card 232. Further, for each television channel (multicast group address), the multicast forwarding table includes a list of all of the line cards that are to receive the multicast data packets of the television channel, along with path information for fabric switch module card 238.

The host line cards 234, which can also be implemented with xDSL line cards, are connected to a number of end users 244, such as set top boxes. The host line cards 234 also have a multicast forwarding table that lists the television channels (multicast group addresses) that are to be received by the end users 244 (e.g., set top boxes).

Intersystem line card 236 is connected externally to receive multicast data packets that represent the first television channels from intersystem line card 216, and to output multicast data packets that represent the second television channels to intersystem line card 216 of access system 210.

Intersystem line card 236 is also connected internally to the host line cards 234 via fabric switch module card 238 as forwarding destinations for the data packets of the first television channels, and internally to multicast line card 232 via fabric switch module card 238 to receive the multicast data packets of the second television channels. Further, in the present example, intersystem line card 236 is not connected to any end users 244, and can never be connected to any end users 244.

In addition, intersystem line card 236 has both an outgoing multicast forwarding table and an incoming multicast forwarding table. The outgoing multicast forwarding table lists all of the second television channels (multicast group addresses) that are received from multicast line card 232 and, for each received television channel, defines intersystem line card 216 as the forwarding destination for the multicast data packet.

The incoming multicast forwarding table lists all of the first television channels (multicast group addresses) that are received by intersystem line card 236 from intersystem line card 216 and, for each television channel (multicast group address), the multicast forwarding table includes a list of all of the host line cards 234 that are to receive the television channel, along with path information for fabric switch module card 238.

Fabric switch module card 238, which is connected to multicast line card 232, host line card 234, and intersystem line card 236, passes data packets between the line cards at up to OC12 speeds. Primary control module card 240 receives non-packet control messages from, and outputs non-packet control messages to, multicast line card 232, host line card 234, intersystem line card 236, and fabric switch module card 238 over control bus 242.

As additionally shown in FIG. 2, communication system 200 includes a fiber optic cable 250 that is connected to both intersystem line card 216 of access system 210 and intersystem line card 236 of access system 230.

In operation, multicast line card 212 receives the first television channels from a forwarding unit 252, such as a router or a video head end, and forwards the first television channels to the host line cards 214 and intersystem line card 216 via fabric switch module card 218 as indicated by the entries in the multicast forwarding table stored in multicast line card 212.

When a multicast data packet is received by multicast line card 212, multicast line card 212 determines the multicast group address of the packet, checks the multicast forwarding table to determine which line cards are to receive the television channel represented by the multicast group address, and forwards the data packet to the line cards which are to receive the television channel using the path information.

For example, multicast line card 212 can receive first television channels 1-50 (with corresponding multicast group addresses of 1-50) from a video head end A 252. When the end users 224 connected to a host line card 214A, as a group, receive all of the channels 1-50, the multicast forwarding table of multicast line card 212 associates the host line card 214A with all of the received television channels. Thus, in this example, multicast line card 212 forwards all of the first television channels 1-50 to host line card 214A, to be forwarded on to the end users 224.

In accordance with the present invention, the multicast forwarding table of multicast line card 212 also associates intersystem line card 216 with each received television channel. As a result, multicast line card 212 forwards all of the television channels 1-50 to intersystem line card 216.

When a multicast data packet for one of the first television channels (1-50) is received by intersystem line card 216, line card 216 determines the multicast group address of the packet, checks the outgoing multicast forwarding table to determine which line cards are to receive the television channel represented by the multicast group address, and forwards the multicast data packet to intersystem line card 236 as indicated by the outgoing multicast forwarding table.

In further accordance with the present invention, intersystem line card 216 also receives the second television channels from intersystem line card 236, and forwards the second television channels to the host line cards 214 via fabric switch module card 218 as indicated by the incoming multicast forwarding table stored in intersystem line card 216.

When a multicast data packet for one of the second television channels (51-100) is received by intersystem line card 216, line card 216 determines the multicast group address of the packet, checks the incoming multicast forwarding table to determine which host line cards 214 are to receive the television channel represented by the multicast group address, and forwards the data packet to the host line cards 214 which are to receive the television channel using the path information.

Thus, in accordance with the present invention, host line card 214 can receive multicast television channels 1-100 by receiving channels 1-50 from multicast line card 212 and channels 51-100 from intersystem line card 216.

In addition to the above, multicast line card 232 receives the second television channels from a forwarding unit 254, such as a router or a video head end, and forwards the second television channels to the host line cards 234 and intersystem line card 236 via fabric switch module card 238 as indicated by the entries in the multicast forwarding table stored in multicast line card 232.

When a multicast data packet is received by multicast line card 232, multicast line card 232 determines the multicast group address of the packet, checks the multicast forwarding table to determine which line cards are to receive the television channel represented by the multicast group address, and forwards the multicast data packet to the line cards which are to receive the television channel using the path information.

For example, multicast line card 232 can receive second television channels 51-100 (with corresponding multicast group addresses of 51-100) from a video head end B 254. When the end users 244 connected to a host line card 234A, as a group, receive all of the channels 51-100, the multicast forwarding table of multicast line card 232 associates host line card 234A with all of the received television channels. Thus, in this example, multicast line card 232 forwards second television channels 51-100 to host line card 234A, to be forwarded on to the end users 244.

In accordance with the present invention, the multicast forwarding table of multicast line card 232 also associates intersystem line card 236 with each received television channel. As a result, multicast line card 232 forwards all of the second television channels 51-100 to intersystem line card 236.

When a multicast data packet for one of the second television channels (51-100) is received by intersystem line card 236, line card 236 determines the multicast group address of the packet, checks the outgoing multicast forwarding table to determine which line cards are to receive the television channel represented by the multicast group address, and forwards the data packet to intersystem line card 216 as indicated by the outgoing multicast forwarding table.

In further accordance with the present invention, intersystem line card 236 also receives the first television channels from intersystem line card 216, and forwards the first television channels to the host line cards 234 via fabric switch module card 238 as indicated by the incoming multicast forwarding table stored in intersystem line card 236.

When a multicast data packet for one of the first television channels (1-50) is received by intersystem line card 236, line card 236 determines the multicast group address of the packet, checks the multicast forwarding table to determine which host line cards 234 are to receive the television channel represented by the multicast group address, and forwards the multicast data packet to the host line cards 234 which are to receive the television channel using the path information.

Thus, in accordance with the present invention, the host line cards 234 can receive multicast television channels 1-100 by receiving channels 1-50 from intersystem line card 236 and channels 51-100 from multicast line card 232.

One of the advantages of the present invention is that communications system 200 allows company A, which sources television channels 1-50 via head end A, and company B, which sources television channels 51-100 via head end B, to easily share television channels, thereby allowing company A and company B to each provide 100 channels of video content.

It should be understood that the above descriptions are examples of the present invention, and that various alternatives of the invention described herein may be employed in practicing the invention. Thus, it is intended that the following claims define the scope of the invention and that structures and methods within the scope of these claims and their equivalents be covered thereby.

What is claimed is:

1. An access system comprising:
a host line card, the host line card being connectable to an end user; and
a multicast line card electrically connected to the host line card to pass packets of data to the host line card, the multicast line card receiving a multicast data packet that has a multicast group address, the multicast line card having a multicast forwarding table that includes the multicast group address and an indication of whether the multicast data packet with the multicast group address is to be forwarded to the host line card.

2. The access system of claim 1 and further comprising an intersystem line card, the multicast line card being electrically connected to the intersystem line card to pass data packets to the intersystem line card, the intersystem line card never being connected to an end user.

3. The access system of claim 2 wherein the multicast forwarding table includes an indication that the multicast data packet with the multicast group address is to be forwarded to the intersystem line card.

4. The access system of claim 3 wherein the intersystem line card forwards the multicast data packet to an external line card, the external line card never being connected to an end user.

5. An access system comprising:
a plurality of host line cards, each host line card being connected to a plurality of end users;
a multicast line card electrically connected to the host line cards to pass packets of data to the host line cards, the multicast line card receiving a plurality of multicast data packets that have a plurality of multicast group addresses, the multicast line card having a multicast forwarding table that defines the host line cards that are to receive the multicast data packets with the multicast group addresses; and
an intersystem line card, the multicast line card being electrically connected to the intersystem line card to pass data packets to the intersystem line card, the intersystem line card not being connected to any end users.

6. The access system of claim 5 wherein the multicast forwarding table includes an indication that the multicast data packets with a number of the multicast group addresses are to be forwarded to the intersystem line card.

7. The access system of claim 6 wherein all of the multicast data packets are forwarded to the intersystem line card.

8. The access system of claim 7 wherein the intersystem line card forwards the multicast data packets to an external line card, the external line card not being connected to any end users.

9. A communications system comprising:
a first access system including:
a plurality of first host line cards;
a first multicast line card electrically connected to the first host line cards to pass packets of data to the first host line cards, the first multicast line card receiving a plurality of first multicast data packets that have a plurality of first multicast group addresses, the first multicast line card having a first multicast forwarding table that defines the first host line cards that are to receive the first multicast data packets with the first multicast group addresses; and
a first intersystem line card, the first multicast line card being electrically connected to the first intersystem line card to pass packets of data to the first intersystem line card; and
a second access system including:
a plurality of second host line cards;
a second multicast line card electrically connected to the second host line cards to pass packets of data to the second host line cards, the second multicast line card receiving a plurality of second multicast data packets that have a plurality of second multicast group addresses, the second multicast line card having a second multicast forwarding table that defines the second host line cards that are to receive the second multicast data packets with the second multicast group addresses; and
a second intersystem line card, the second multicast line card being electrically connected to the second intersystem line card to pass packets of data to the second intersystem line card.

10. The communications system of claim 9 wherein the first intersystem line card is connected to the second intersystem line card.

11. The communications system of claim 10 wherein the first intersystem line card forwards the first multicast data packets to the second intersystem line card.

12. The communications system of claim 11 wherein the second intersystem line card forwards the first multicast data packets to the second host line cards in accordance with a forwarding table in the second intersystem line card.

13. The communications system of claim 12 wherein the second multicast line card forwards the second multicast data packets to the second host line cards in accordance with the second multicast forwarding table in the second multicast line card.

14. The communications system of claim 13 wherein the first intersystem line card forwards the first multicast data packets to the second intersystem line card.

15. The communications system of claim 14 wherein the second intersystem line card forwards the first multicast data packets to the second host line cards in accordance with a forwarding table in the second intersystem line card.

16. The communications system of claim 15 wherein the second multicast line card forwards the second multicast data packets to the second host line cards in accordance with the second multicast forwarding table in the second multicast line card.

17. A method of providing digital television service to an end user, the method comprising the steps of:
receiving a multicast data packet with a multicast line card, the multicast data packet having a multicast group address; and
forwarding the multicast data packet from the multicast line card to a host line card in accordance with a forwarding table that associates the multicast group address with the host line card.

18. The method of claim 17 and further comprising the step of forwarding the multicast data packet from the multicast line card to an intersystem line card.

19. The method of claim 18 and further comprising the step of forwarding the multicast data packet from the intersystem line card to an external line card.

20. The method of claim 19 and further comprising the step of forwarding multicast data packets from the intersystem line card to the host line card.
